(19) United States
(12) Patent Application Publication
(10) Pub. No.: US 2026/0105017 A1
(43) Pub. Date: Apr. 16, 2026

(54) POWER ADAPTER WITH INTEGRATED TRACKER

(71) Applicant: TWELVE SOUTH, LLC, NORTH CHARLESTON, SC (US)

(72) Inventors: ANDREW BRADFORD GREEN, NORTH CHARLESTON, SC (US); CHRISTINA TAPP, NORTH CHARLESTON, SC (US)

(21) Appl. No.: 19/318,457

(22) Filed: Sep. 4, 2025

Related U.S. Application Data
(60) Provisional application No. 63/691,150, filed on Sep. 5, 2024.

(51) Int. Cl. G06F 13/40; H04W 4/029

(52) U.S. Cl. CPC G06F 13/4068; H04W 4/029; G06F 2213/0042

(57) ABSTRACT

A power supply or power adapter for supplying power to electric devices, including portable electronic devices, with an integrated tracker. The integrated tracker is able to wirelessly communicate with nearby mobile and computing devices which are part of a crowd-sourced network of a plurality of mobile devices and computing devices. The network crowdsources location data for these other nearby devices which securely and anonymously report the integrated tracker's location, and thus the power supply or adapter's location, even if the power supply or adapter is “offline.”

This application claims benefit of and priority to U.S. Provisional App. No. 63/691,150, filed Sept. 5, 2024, which is incorporated herein in its entirety by specific reference for all purposes.

### FIELD OF INVENTION

This invention relates generally to power supply or power adapter for supplying power to electric devices, including portable electronic devices, with an integrated tracker, and more specifically a power supply or adapter with an integrated tracker able to communicate with iPhone and other related devices through the “Find My” application.

### BACKGROUND OF THE INVENTION

A number of power adapters are widely known in the prior art for use in supplying power to a variety of portable electronic devices, including computers, tablets, cell phones, smart phones, media players, and the like. The power adapter receives power from an external power source supplying alternating current (AC) voltage, and converts it to direct current (DC) voltage for use by the device for operations or for recharging an internal battery. Power adapters may be limited to a single type of external power supply and may be device-specific, while others have interchangeable plugs or other input means to be used with multiple power supply sources, or that provide alternate outputs. Examples of such devices include the power adapters disclosed in U.S. Pat. Nos. 5,019,767 (issued May 28, 1991); 5,684,689 (issued Nov. 4, 1997); 6,086,395 (issued July 11, 2000); 9,368,966 (issued Dec. 29, 2020); and 10,601,224 (issued March 21, 2023); the specifications, drawings and disclosures of which are incorporated herein in their entireties by specific reference for all purposes.

Many users have multiple devices that require frequent charging. These often require different, device-specific power supplies or adapters, or multiple cables, which require the user to carry separate power supplies or adapters around for each device. Such power supplies or adapters often become misplaced or lost in the home or office, requiring extensive searching and/or replacement. The problem may be exacerbated when a device user frequently travels, as a power supply or adapter may easily be misplaced in luggage, or left or lost in a hotel room, rental car, or other location.

### BRIEF DESCRIPTION OF THE DRAWINGS

FIG. 1 shows a perspective view of an exemplary embodiment of a power supply with integrated tracker plugged into a wall outlet.

FIG. 2 shows another perspective view of an exemplary embodiment of a power supply with integrated tracker.

FIG. 3 shows a perspective view of an exemplary embodiment of a power supply with integrated tracker plugged into a wall outlet and connected to compatible devices.

FIG. 4 shows a bottom view of the power supply with integrated tracker of FIG. 2.

FIG. 5 shows another perspective view of the power supply with integrated tracker of FIG. 2.

### DESCRIPTION OF EXEMPLARY EMBODIMENTS OF INVENTION

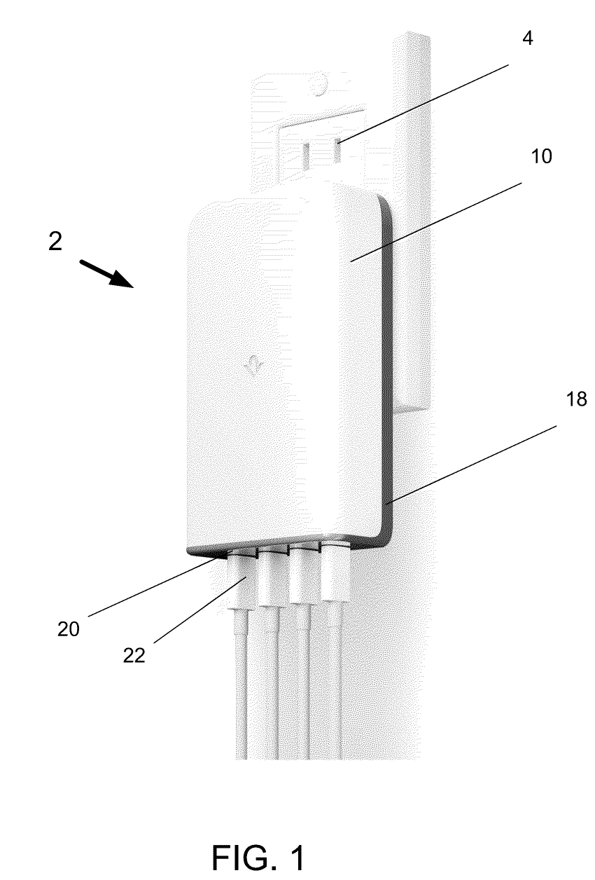

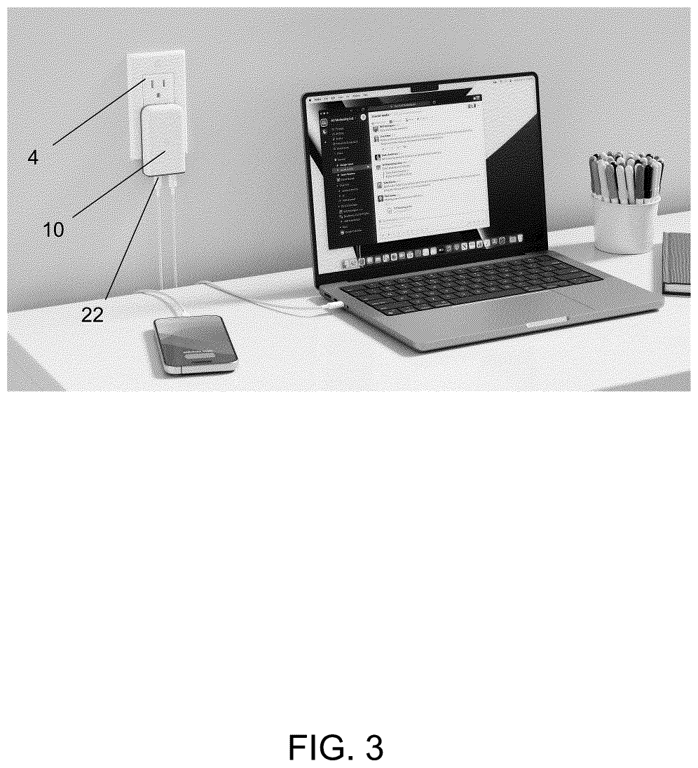

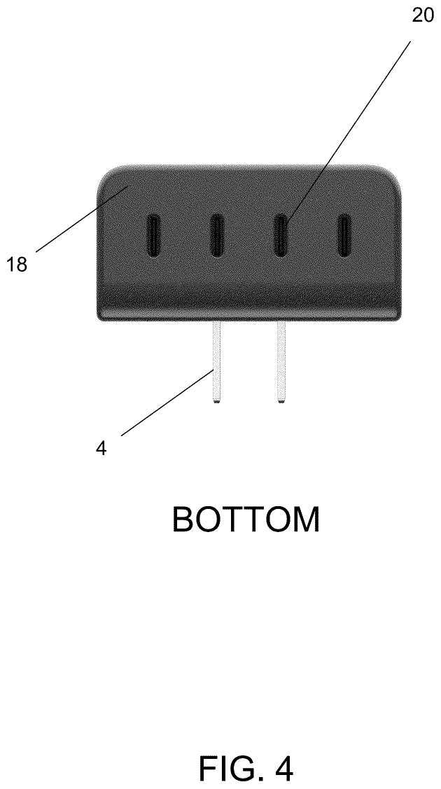

In various embodiments, the present invention comprises a power supply or power adapter 2, typically used to provide power to one or more electronic devices, with an integrated tracker 14 in the power supply or adapter housing 10, as seen in FIGS. 1-5. The supply or adapter described herein may be used with any applicable electronic device, including portable electronic devices. Such devices include, but are not limited to, computer, laptop computers, notebook computers, tablet computing devices, cell phones, smart phones, personal digital assistants (PDAs), media or music players, recorders, televisions, speakers, earphones, headphones, and the like.

In several exemplary embodiments, the integrated tracker is compatible with the Apple Inc. “Find My” network and related application, which comprise a crowd-sourced network of a large number of Apple devices using Bluetooth wireless technology to track or detect devices or items, even if the device or item is not powered (i.e., power is off or the device is not plugged in) or offline (i.e., not in direct wireless communication with a standard telecommunications network). The integrated tracker comprises a Bluetooth-compatible wireless communications chip or port, which may comprise or be a component of an integrated circuit or application-specific integrated circuit within the power supply or adapter, and which may or may not comprise a Global Positioning System (GPS) chip or device, for communicating with nearby Apple devices which form part of the Find My network. The Find My network crowdsources location data for these other nearby Apple device which securely and anonymously report the integrated tracker's location, and thus the power supply or adapter's location, even if the power supply or adapter is “offline.” Thus, the power supply or adapter may be identified and located by a user using the Find My application on their iPhone, iPad, Apple computer, or other Apple device. U.S. Pat. No. 7,552,031, issued Jun. 23, 2009 to Apple Inc., is incorporated herein in its entirety by specific reference for all purposes. Offline finding (OF) also is further discussed in Alexander Heinrich, et al., “Who Can Find My Devices? Security and Privacy of Apple's Crowd-Sourced Bluetooth Location Tracking System,” published March 2021 and available publicly online at https://www.researchgate.net/publication/349758797_Who_Can_Find_My_Devices_Security_and_Privacy_of_Apple's_Crowd-Sourced Bluetooth_Location_Tracking_System; and which is incorporated herein in its entirety by specific reference for all purposes.

FIGS. 1-5 show an exemplary embodiment of the present invention, comprising a multi-port USB-C wall charger with “Find My” functionality. The wall charger 2 has a housing 10 with folding set of plugs or prongs 12 on a face, designed to plug into standard wall outlets 4. The plugs or prongs 12 may be foldable for ease of travel and/or storage of the charger 2. The integrated tracker 14 is disposed inside the housing.

Multiple ports, including but not limited to USB-C ports 20, may be located along the bottom, sides, and/or top or outer face of the housing, into which compatible power supply/communications cables 22 may be inserted. While the figures show USB-C ports, other forms of ports, such as USB-A, USB-B, USB mini, USB micro ports, and/or other ports compatible with USB 2.0, 3.0, 3.1 or 4.0 standards may be used or included. The charger housing may have 1 port, 2 ports, 3 ports, 4 ports, or more. The total power supplied may be 50 W, 120 W, or other amount as appropriate for the number of ports and intended use.

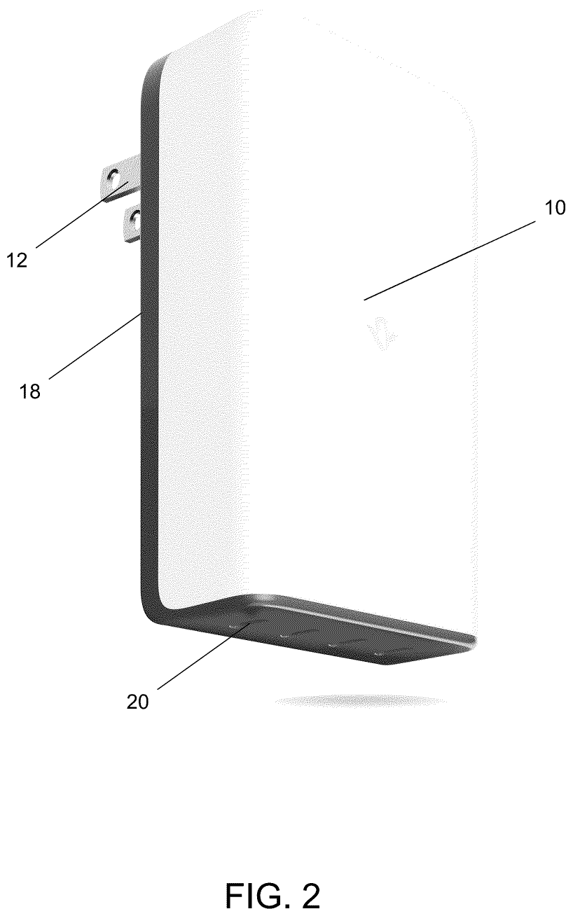

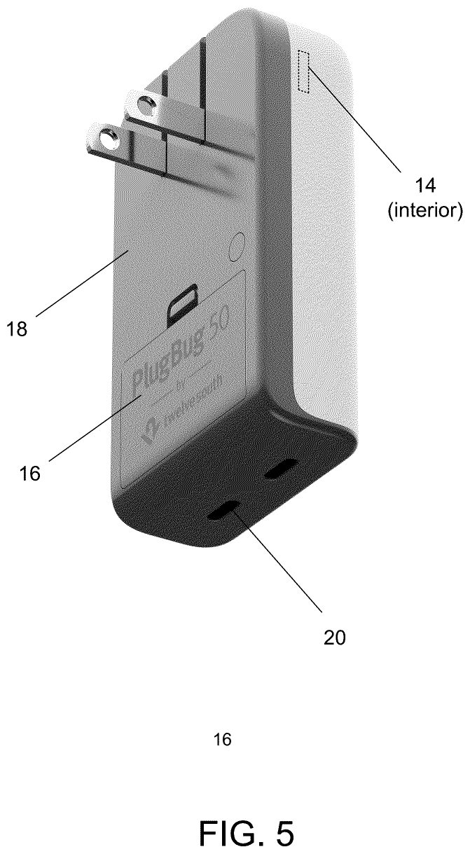

The housing 10 of the charger 2 is flattened by comparison to prior art chargers to save space by laying flat against walls and outlets 4. This is reflected in the relative dimensions of the various embodiments of the charger. In several embodiments, the thickness of the charger (with plugs folded) is approximately 40% to 60% of the width of the charger. In some embodiments, the thickness is approximately one-half or less than one-half the width. For example, the 2-port charger embodiment shown in FIG. 5 has a height (or length) of 83 mm, a width of 49 mm, and a thickness (or depth) of 22.5 mm. As another example, the 4-port charger embodiment shown in FIGS. 1 and 2 has a height (or length) of 103.5 mm, a width of 60 mm, and a thickness (or depth) of 31.5 mm.

In the embodiments shown, the housing has a bold accent color 18 to set it apart from other monochromatic (i.e., black or white) chargers, and to help identify the device at a glance. In the embodiment shown, the accent color is red, and appears on the inner face and the lower side. The charger 2 further comprises an internal battery 16 located inside the housing (e.g., a GaN or CR2032 battery). Additional exemplary information may be found in the appendix (2 pp) to the provisional application, which is incorporated herein in its entirety by specific reference for all purposes.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A power adapter, comprising:
a housing with an inner face, an outer face, and a bottom side;
a power input portion on and integrated with the inner face said housing and capable of being connected to a power source;
a plurality of power outputs; and
an integrated tracker.

2. The power adapter of claim 1, wherein the power input portion comprises a pair of prongs.

3. The power adapter of claim 2, wherein the pair of prongs are foldable.

4. The power adapter of claim 1, wherein the plurality of power inputs comprise USB ports.

5. The power adapter of claim 4, wherein the USB ports comprise at least one USB-C port.

6. The power adapter of claim 4, wherein the USB ports comprise four USB-C ports.

7. The power adapter of claim 1, wherein the tracker comprises a wireless communications chip.

8. The power adapter of claim 7, wherein the tracker comprises a Bluetooth wireless communications chip.

9. The power adapter of claim 1, wherein the tracker comprises a GPS chip.

10. The power adapter of claim 1, wherein the tracker comprises an integrated circuit or is a component of an integrated circuit.

11. The power adapter of claim 1, wherein the tracker comprises an application-specific integrated circuit or is a component of an application-specific integrated circuit.

12. The power adapter of claim 1, wherein the tracker is in wireless communication with a crowd-sourced network.

13. The power adapter of claim 12, wherein the crowd-sourced network is a “Find My” network comprising a plurality of Apple Inc. devices.

14. The power adapter of claim 13, wherein the location of the power adapter is capable of being determined by interaction with the crowd-sourced network.

15. The power adapter of claim 14, wherein the location of the power adapter is displayable on a device within the crowd-sourced network.
